(19) United States
(12) Patent Application Publication
(10) Pub. No.: US 2011/0169257 A1
(43) Pub. Date: Jul. 14, 2011

(54) BOOK

(76) Inventor: Kate Stone, Cambridge (GB)

(21) Appl. No.: 13/056,595

(22) PCT Filed: Jul. 31, 2009
(86) PCT No.: PCT/GB2009/050954

§ 371 Date: Mar. 16, 2011

(30) Foreign Application Priority Data
Jul. 31, 2008 (GB) 0813983.4

(51) Int. Cl. B42D 1/00; B42C 11/00

(52) U.S. Cl. 281/15.1; 412/4

(57) ABSTRACT

A book comprises at least one page (2), the or each page comprising a laminate (3) of at least two sheet portions (4, 5) and a printed circuit sheet (17) comprising a substrate and conductive tracks disposed on the substrate. The printed circuit sheet has first and second portions (20, 21). At least some of the conductive tracks run from the first to the second portion of the printed circuit sheet. The second portion of the printed circuit sheet comprises at least two fingers (25). Each finger supports at least one electronic device for providing user input and/or output. Each finger (25) is inserted into a respective page (2) in between sheet portions.

The present invention relates to a book.

Electronic printed books, i.e. printed books which include electronic devices, are known.

For example, WO-A-94 12963 describes an electronic book comprising a plurality of leaves. Each leaf comprises pages of printed material bound at one edge to form a spine with electrical circuits formed in each leaf. A common electronic circuit, such as a speech generator and/or controller, cooperates with the electrical circuits on each of the various pages, connected to the electrical circuits in the leaves through conductive paths through the spine of the book. The electrical circuits in the leaves include electrical elements, such as switches, and sensory output devices, such as light emitting diodes. To connect the common electrical circuit to the circuits in each leaf, the book employs a corrugated continuous sheet on which ink is printed. The continuous sheet forms either the leaves of the book or a spine of flaps between which leaves are inserted.

GB-A-2 440 730 describes a book including interconnected electrical components. The book is made by applying conductive ink to a sheet of material to define a conductive track on the sheet. The conductive track extends beyond the edge of the sheet to form an electrical connection. Pages are individually cut and glued to a spine, bound with fabric carrying which is screen printed with conducting ink and which is glued to the spine. Links are led to the edge of the paper via conductive ink lines. Lines of conductive ink are led to a hard cover, to a printed circuit board with a microcontroller.

According to a first aspect of the present invention there is provided a book comprising at least two pages, each page comprising a laminate of at least two sheet portions and a printed circuit sheet comprising a substrate and conductive tracks disposed on the substrate, wherein the printed circuit sheet has first and second portions, wherein at least some of the conductive tracks run from the first to the second portion of the printed circuit sheet, wherein the second portion of the printed circuit sheet comprises at least two fingers, wherein each finger supports at least one electronic device for providing user input and/or output and wherein each finger is inserted into a respective page in between sheet portions.

Thus, a circuit can be easily incorporated into the book.

The first portion of the printed circuit sheet may support at least part of a circuit operatively connected to the at least one electronic device. The at least part of a circuit may include a microcontroller. The first portion of the printed circuit sheet may support a battery.

The conductive tracks may comprise conductive ink. The substrate may be flexible and may comprise a plastics material. The substrate may be formed in a single piece.

The book may include a cover comprising a laminate of at least two sheet portions. The first portion of the printed circuit sheet may be inserted into a page or cover in between the sheet portions.

The first portion of the printed circuit sheet may comprise at least three fingers. The fingers may have the same shape and/or dimensions.

Each finger may be provided with at least one electronic device for providing user input and/or output. The fingers may extend from the first portion of the printed circuit sheet. The fingers may be attached at respective proximal ends to the first portion of the printed circuit sheet. The fingers may extend from one edge of the first portion of the printed circuit sheet.

The at least one electronic device may include at least one input device. The at least one input device may include a switch. The switch may comprise a pair of conductive pads separated by gap which is bridgeable by a finger of a user.

The at least one electronic device include at least one output device. The at least one output device may include a light emitting device, such as a light emitting diode. The at least one output device may include a display.

The at least one output device may include a sound emitting device.

The first portion of the printed circuit sheet may support at least one electronic device for providing user input and/or output.

The printed circuit sheet may comprise first and second faces and the conductive tracks may be disposed on both faces.

The printed circuit sheet may comprise first and second faces, wherein the conductive tracks are disposed on the first face, wherein the printed circuit sheet further comprises a third region, wherein the printed circuit sheet is foldable so that the third region lies overlaps with the second region and the second and third regions have opposite-facing first faces.

The book may be a board book.

According to a second aspect of the present invention there is provided a printed circuit sheet for integrating into a book comprising a substrate and conductive tracks disposed on the substrate, wherein the printed circuit sheet has first and second portions, wherein at least some of the conductive tracks run from the first to the second portion of the printed circuit sheet, wherein the second portion of the printed circuit sheet comprises at least two fingers, each finger provided with at least one electronic device for providing user input and/or output.

According to a third aspect of the present invention there is provided a method of bookbinding comprising providing a printed circuit sheet comprising a substrate and conductive tracks disposed on the substrate, wherein the printed circuit sheet has first and second portions, wherein at least some of the conductive tracks run from the first to the second portion of the printed circuit sheet, wherein the second portion of the printed circuit sheet comprises at least two fingers, each finger provided with at least one electronic device for providing user input and/or output, providing at least two pages, each page comprising a laminate of two sheet portions, and inserting a finger into a respective page in between sheet portions.

The laminate may comprise a folded sheet comprising the first and second sheet portions.

The method may further comprise inserting the first portion of the printed circuit sheet into a page or cover in between the sheet portions.

Embodiments of the present invention will now be described, by way of example, with reference to the accompanying drawings in which:

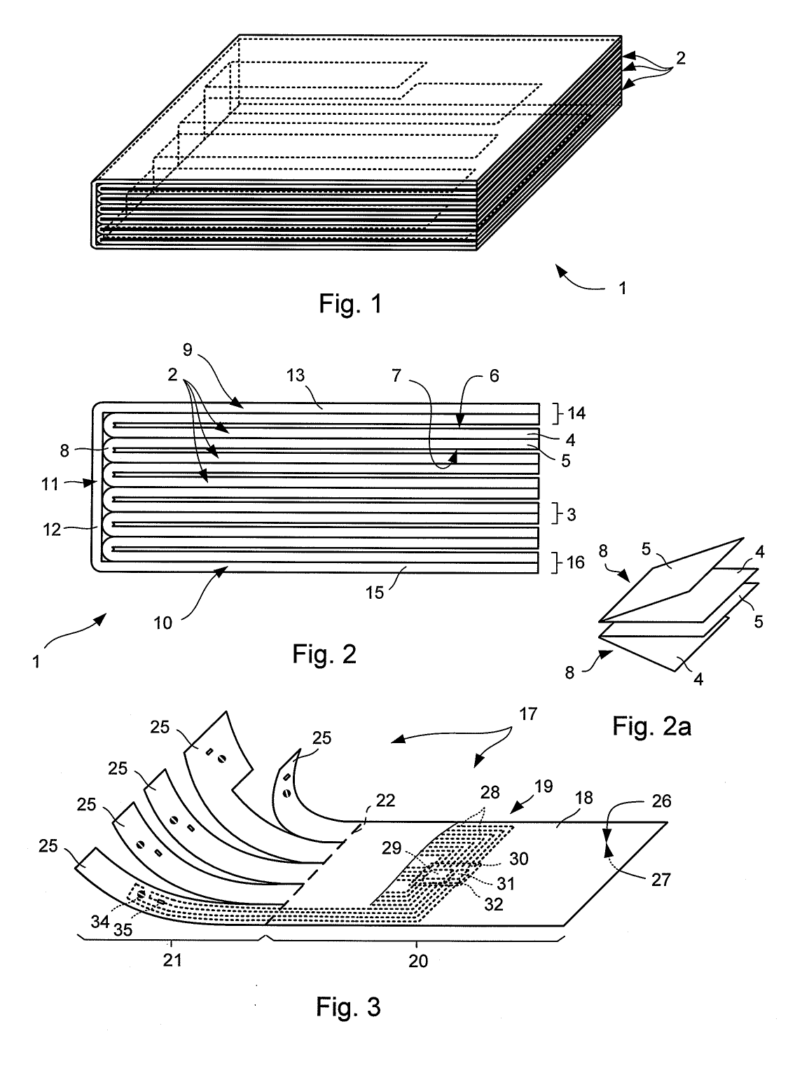

FIG. 1 is a perspective view of an embodiment of book in accordance with the present invention;

FIG. 2 is end view of the book shown in FIG. 1;

FIG. 2a is a perspective view of two folded sheets;

FIG. 3 is a perspective view of a printed circuit sheet included in the book shown in FIG. 1;

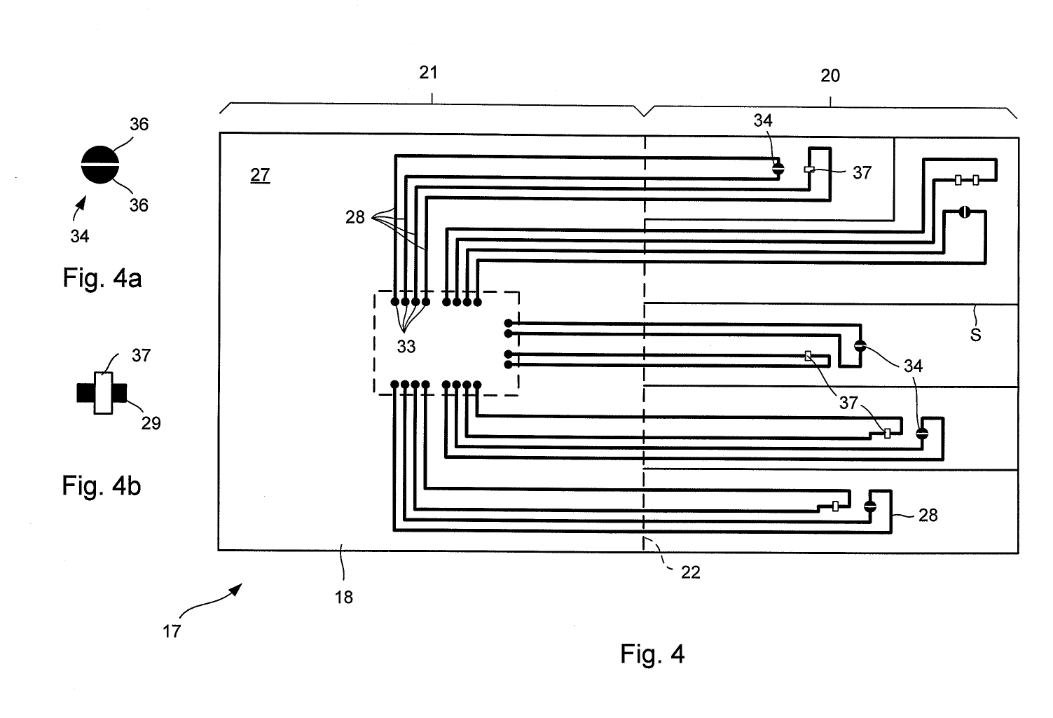

FIG. 4 is a plan view of the printed circuit sheet shown in FIG. 3;

FIG. 4a is a detailed plan view of a switch used in the circuit shown in FIG. 4;

FIG. 4b is a detailed plan view of part of the circuit where a light emitting diode is mounted;

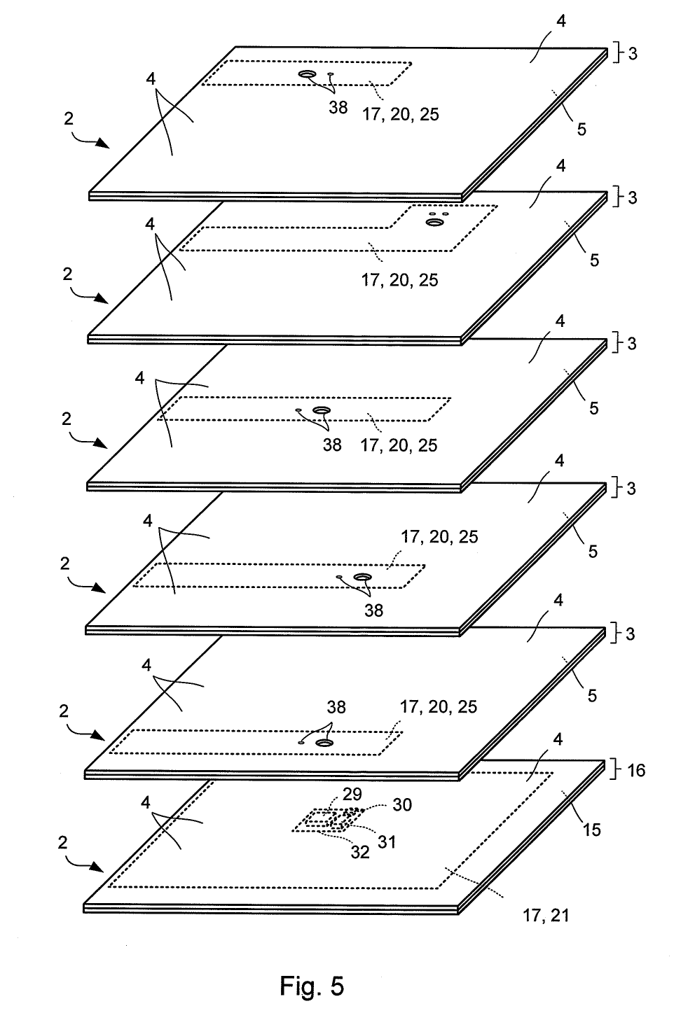

FIG. 5 is an exploded view of a portion of the book shown in FIG. 1;

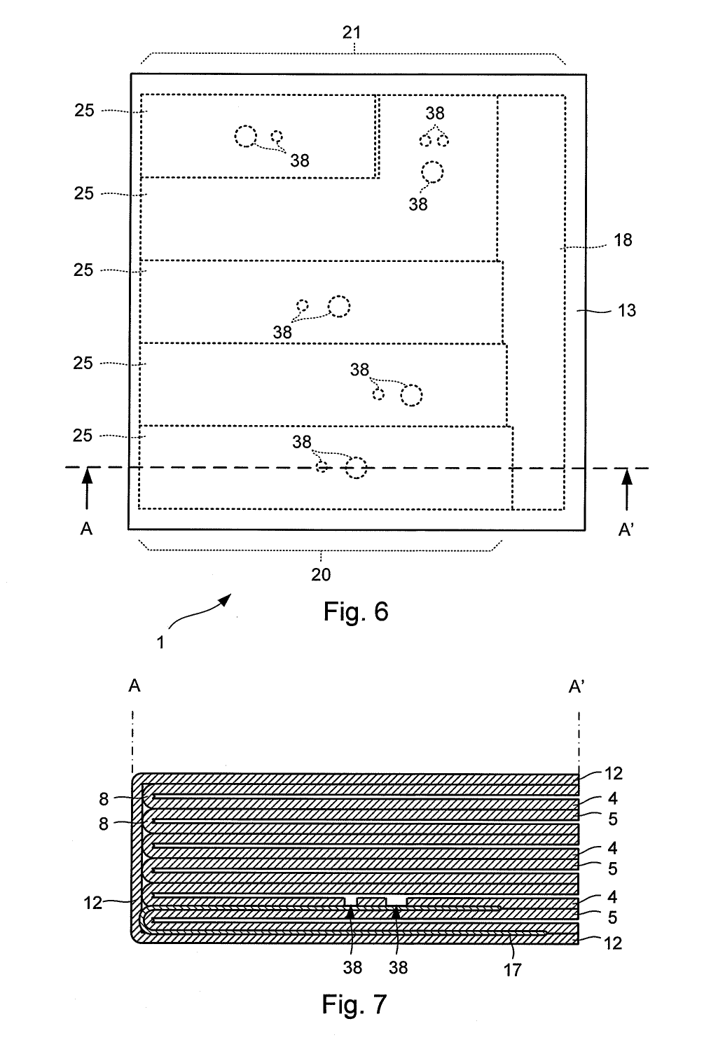

FIG. 6 is a plan view of the book shown in FIG. 1;

FIG. 7 is a cross section of the book shown in FIG. 1 taken along the line A-A′; and

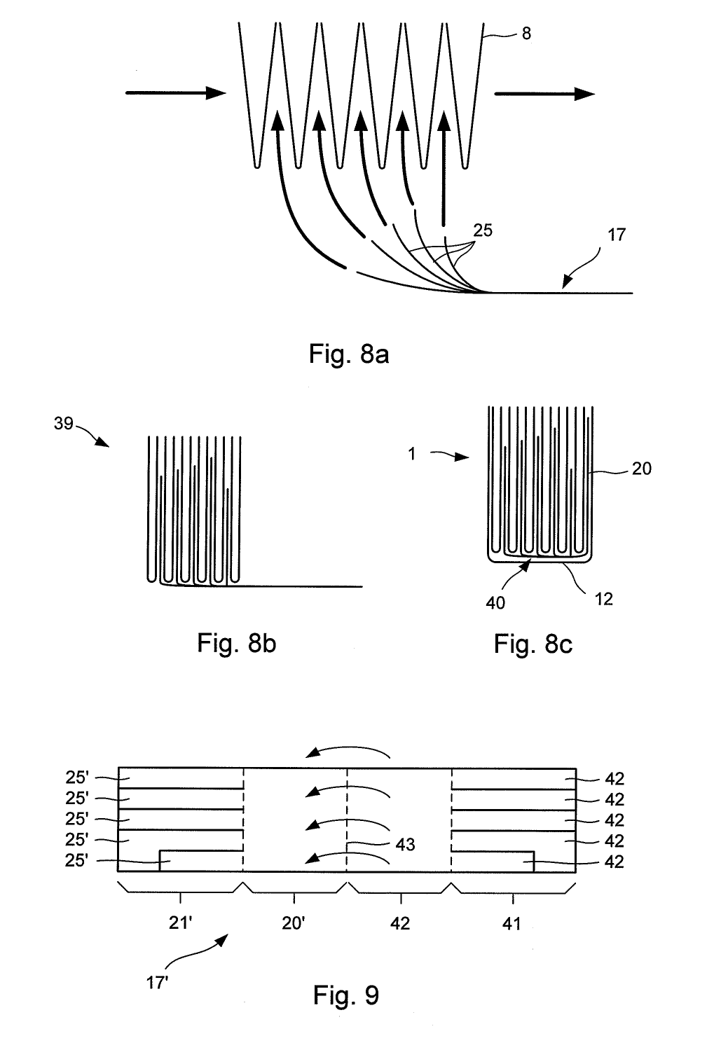

FIGS. 8a to 8c illustrate steps during manufacture of the book shown in FIG. 1.

Referring to FIGS. 1 and 2, a book 1 in accordance with the present invention is shown. In this example, the book 1 is a children's board book comprising board or stiff card.

The book 1 includes a plurality of leaves or pages 2, each page 2 comprising a laminate 3 including first and second sheet portions 4, 5. Each page 2 has first and second sides 6, 7 bearing printed indicia. In this example, the book 1 comprises five pages 2, although the book 1 may contain fewer or more pages.

Referring also to FIG. 2a, the laminates 3 are formed using a plurality of folded sheets 8 comprising, in this case, board or stiff card, in which a first sheet portion 4 (e.g. right-hand side of the sheet 8) of one sheet 8 is joined to a second sheet portion 5 (e.g. left-hand side of the sheet) of another sheet 8. The sheet portions 4, 5 in a laminate 8 are stuck together using glue (not shown).

The book 1 also includes front and back covers 9, 10 and a spine 11. The front and back covers 9, 10 share a cover sheet 12 comprising board or stiff card. A portion 13 of the cover sheet 12 is laminated with a first portion 4 of a first sheet 8 as to form a front cover laminate 14. Likewise, a portion 15 of the cover sheet 12 is laminated with a second portion 5 of a last sheet 8 as to form a back cover laminate 16.

Referring also to FIGS. 3 and 4, the book 1 includes a printed circuit sheet 17 comprising a flexible substrate 18 which supports a circuit 19.

The printed circuit sheet 17 is divided into first and second portions 20, 21. In this example, the printed circuit sheet 17 is generally elongate and is divided along a line 22 running across the sheet 17. Thus, the line 22 defines an edge between first and second portions 20, 21.

Extending away from the first portion 20 of the printed circuit sheet 17, the second portion 21 of the sheet 17 comprises a row of two or more separate ribbon-like fingers or strips 25 which can be independently folded back over the first portion 20 of the printed circuit sheet 17. The fingers 25 are separated by slits or cuts S.

Referring in particular to FIG. 5, one or more fingers 25 can be provided for one or more pages 2. In this example, a finger 25 is sandwiched between sheet portions 4, 5 of each respective laminate 3. The fingers 25 are generally elongate and run across the page.

Referring in particular again to FIGS. 3 and 4, the printed circuit sheet 17 has first and second faces 26, 27.

The circuit 19 is provided on one or both faces of the printed circuit sheet 17. In this example, the circuit 19 is provided only on the second face 27.

The circuit 19 includes a plurality of tracks 28 comprising conductive ink which connects other components. The tracks 28 comprise a silver-based conductive ink. Suitable conductive inks are available from Sun Chemical Corporation, Parsippany, New Jersey, USA. Other forms of conductive ink can be used, such as a copper-based conductive ink or some other metallic-based conductive ink, or a carbon-based conductive ink. The tracks 28 are formed using a printing process, such as screen printing, ink jet printing, flexography or offset printing.

The circuit 19 also includes a microcontroller 29, associated discrete components 30 and a battery 31. In this example, the microcontroller 29, discrete components 30 and battery 31 are provided on a printed circuit board 32. The printed circuit board 32 is connected to contact pads 33 at the end of the tracks 28 by conductive glue (not shown). The microcontroller 29 may be a PIC(RTM) microcontroller available from Microchip Technology Inc., Chandler, Ariz., USA.

Additional or alternative power sources can be provided. For example, a solar cell may be used, which may be disposed in or on a page or cover. Where the solar cell is located disposed in a page or cover (i.e. inserted between sheet portions) a window is provided in a sheet portion.

The circuit 19 also includes switches 34 and light emitting diodes 35 disposed on the fingers 25.

Referring to FIG. 4a, each switch 34 takes the form of a resistive touch sensitive switch comprising a pair of closely-separated pads 36 which are bridgeable by a finger of a user. However, other forms of switch can be used, such as a push-button switch (e.g. a dome switch) or a non-contact switch (e.g. a capacitive sensing switch). Other forms of input device can be used, such as photoresistor or microphone. Different types of input device may be used, e.g. a switch on one page and photoresistor on another page.

Referring again to FIGS. 3 and 4 and also to FIG. 4b, the light emitting diodes 35 comprise ultra-thin surface mount light emitting diodes which are glued to the tracks 28 by conductive glue (not shown). Holes or slots 37 are punched-out from the sheet 17 to break a track 28 so as to prevent conductive glue flowing together to short the contacts.

Light emitting diodes may be formed directly on the substrate 18, e.g. in the form of organic light emitting diodes. Other forms of light or visual output device can be used, such as electrochromic display.

Sound emitting devices may also be used, such as speakers or buzzers. In particular, a sound emitting device may be incorporated into the back or front cover.

The printed circuit sheet 17 is formed from one piece. However, the sheet 17 may be assembled from more than one piece. For example, fingers may be attached to a base sheet which may have contact regions or may have short fingers, i.e. tabs or stubs, to which fingers or sheets may be attached to the fingers so as to provide extensions. This can enable devices to be spread across more of a page, even across the whole page.

To enable a reader to actuate the switches 34 and to see the light emitting diodes 35, holes or slots 38 are punched-out from the sheet 8. The switches 34 and light emitting diodes 35 positioned on the sheet 17 so as to be aligned with the holes 38.

Referring to FIGS. 8a to 8d, a method of manufacturing the book (FIG. 1) will now be described.

As folded sheets 8 (also referred to as “two-page spreads”) are joined together, glue is applied and a finger 25 is inserted between the sheets 8. The folded sheets 8 are assembled until a book block 39 is completed.

A cover 12 is then wrapped around a backbone 40 of the book block 39 and is attached by glue (not shown). The first portion 20 of the printed circuit sheet 17 is sandwiched between book block 39 and the cover 12. The book 1 may be trimmed.

An advantage of using a printed circuit sheet 17 is that it can be printed in a similar way to the sheets 8 of the book using similar process. Furthermore, the printed circuit sheet 17 can be incorporated into the book more easily than, for example, separate wires or leads, which may require knowledge about where to route the wires. Additionally, a printed circuit sheet 17 and the devices supported by the sheet can be easily placed in the correct position in between sheets. Another advantage is that the printed circuit sheet 17 can be thin (for example of the order of 10 or 100 μm) and flexible.

Referring to FIG. 9, another printed circuit sheet 17′ is shown.

As explained earlier, the conductive tracks 28 (FIG. 3) may be printed on both sides 26, 27 (FIG. 3) of the printed circuit sheet 17 (FIG. 3) so as to allow switches and light emitting diodes to be provided on opposite sides of the same page. However, the need for printing on both sides may be avoided using the printed circuit sheet 17′.

The printed circuit sheet 17′ includes first and second regions 20′, 21′ similar to the printed circuit sheet 17 (FIG. 3) described earlier. The second region 21′ includes a set of fingers 25′ which have the same configuration, e.g. geometry and dimensions, as the fingers 25 (FIG. 3) hereinbefore described.

The printed circuit sheet 17′ includes a third region 41 which includes additional fingers 42 which extend in an opposite direction to fingers 25′. The two sets of fingers 25, 25′ are a mirror image of each other, although they need not be.

The printed circuit sheet 17′ also includes a fourth region 42 between the first and third regions 20, 41. The fourth region 42 may be an extension of the third region.

The third and fourth portions 41, 42 of the printed circuit sheet 17′ can be folded back over the first and second portions 20′, 21′ at fold line 43 separating the first and fourth regions 20′, 42 so that corresponding fingers 25, 25′ in each set of fingers 25, 25′ overlap, e.g. coextensively, to provide back-to-back fingers.

A pair of back-to-back fingers can be inserted between sheet portions of one page and so provide switches and light emitting diodes on both sides of the page without the need for printing on both sides of the printed circuit sheet.

It will be appreciated that many modifications may be made to the embodiments hereinbefore described. For example, the book need not be a board book. The book may be formed from paper, card, cardboard or plastic. Sheets which are laminates per se may be used. The tracks may be covered by other layers of ink providing text or graphics. It will be appreciated that the book may be manufactured using larger-numbered page spreads.

1. A book comprising:
at least two pages, each page comprising a laminate of at least two sheet portions; and
a printed circuit sheet comprising a substrate and conductive tracks disposed on the substrate, wherein the printed circuit sheet has first and second portions, wherein at least some of the conductive tracks run from the first to the second portion of the printed circuit sheet, wherein the second portion of the printed circuit sheet comprises at least two fingers, wherein each finger supports at least one electronic device for providing user input and/or output and wherein each finger is inserted into a respective page in between sheet portions.

2. A book according to claim 1, wherein the first portion of the printed circuit sheet supports at least part of a circuit operatively connected to the at least one electronic device.

3. A book according to claim 2, wherein the at least part of a circuit includes a microcontroller.

4. A book according to claim 1, wherein the first portion of the printed circuit sheet supports a battery.

5. A book according to claim 1, wherein the conductive tracks comprise conductive ink.

6. A book according to claim 1, wherein the substrate is flexible.

7. A book according to claim 1, wherein the substrate comprises a plastics material.

8. A book according to claim 1, wherein the substrate is formed in a single piece.

9. A book according to claim 1, including a cover comprising a laminate of at least two sheet portions.

10. A book according to claim 9, wherein the first portion of the printed circuit sheet is inserted into a page or the cover in between the sheet portions.

11. A book according to claim 1, wherein the first portion of the printed circuit sheet comprises at least three fingers.

12. A book according to claim 1, wherein the fingers extend from the first portion of the printed circuit sheet.

13. A book according to claim 1, wherein the fingers are attached at respective proximal ends to the first portion of the printed circuit sheet.

14. A book according to claim 1, wherein the finger extends from one edge of the first portion of the printed circuit sheet.

15. A book according to claim 1, wherein the at least one electronic device includes at least one input device.

16. A book according to claim 15, wherein the at least one input device includes a switch.

17. A book according to claim 16, wherein the switch comprises a pair of conductive pads separated by gap which is bridgeable by a finger of a user.

18. A book according to claim 1, wherein the at least one electronic device includes at least one output device.

19. A book according to claim 18, wherein the at least one output device includes a light emitting device, such as a light emitting diode.

20. A book according to claim 18, wherein the at least one output device includes a display.

21. A book according to any one of claim 18, wherein the at least one output device includes a sound emitting device.

22. A book according to claim 1, wherein the first portion of the printed circuit sheet supports at least one electronic device for providing user input and/or output.

23. A book according to claim 1, wherein the printed circuit sheet comprises first and second faces and wherein the conductive tracks are disposed on both faces.

24. A book according to claim 1, wherein the printed circuit sheet comprises first and second faces, wherein the conductive tracks are disposed on the first face, wherein the printed circuit sheet further comprises a third region, wherein the printed circuit sheet is foldable so that the third region lies overlaps with the second region and the second and third regions have opposite-facing first faces.

25. A book according to claim 1, wherein the book is a board book.

26. A printed circuit sheet for integrating in a book comprising:
a substrate; and
conductive tracks disposed on the substrate, wherein the printed circuit sheet has first and second portions, wherein at least some of the conductive tracks run from the first to the second portion of the printed circuit sheet, wherein the second portion of the printed circuit sheet comprises at least two fingers, each finger provided with at least one electronic device for providing user input and/or output.

27. A method of bookbinding comprising:
providing a printed circuit sheet comprising a substrate and conductive tracks disposed on the substrate, wherein the printed circuit sheet has first and second portions, wherein at least some of the conductive tracks run from the first to the second portion of the printed circuit sheet, wherein the second portion of the printed circuit sheet comprises at least two fingers, each finger provided with at least one electronic device for providing user input and/or output;
providing at least two pages, each page comprising a laminate of two sheet portions; and
inserting a finger into a respective page in between sheet portions.

28. A method according to claim 27, wherein the laminate comprises a folded sheet, the sheet comprising the first and second sheet portions

29. A method according to claim 27, further comprising:
inserting the first portion of the printed circuit sheet into a page or cover in between the sheet portions.
